(19) United States
(12) Patent Application Publication
(10) Pub. No.: US 2025/0111446 A1
(43) Pub. Date: Apr. 3, 2025

(54) SYSTEMS AND METHODS FOR APPLYING DATA TRANSFORMATIONS FOR PAYROLL ENGINES

(71) Applicant: UKG Inc., Weston, FL (US)

(72) Inventors: Jue Liu, Dublin (IE); Richard Limpkin, Kilkenny (IE)

(21) Appl. No.: 18/476,748

(22) Filed: Sep. 28, 2023

(51) Int. Cl. G06Q 40/12

(52) U.S. Cl. CPC G06Q 40/125

(57) ABSTRACT

Disclosed herein are systems and methods for processing payroll data. A method may identify a plurality of payroll engines for a company, and for each respective payroll engine of the plurality of payroll engines: determine, from a plurality of data types, a respective subset of data types unique to the respective payroll engine and needed to process the payroll transactions based on the unique geographic location associated with the respective payroll engine, and determine a respective data format required by the respective payroll engine to process the payroll transactions. A method may receive payroll data of an employee associated with a first geographic location of the plurality of geographic locations, transform the payroll data corresponding to a first subset of data types into a first data format of the first geographic location; and transmit the payroll data transformed to a first payroll engine of the first geographic location.

### FIELD OF TECHNOLOGY

The present disclosure relates to the field of data storage, and, more specifically, to systems and methods for applying data transformations for payroll engines.

### BACKGROUND

Payroll transactions are an essential part of the world economy as they provide employees with their salaries, employers with their costs, and governmental entities with fees and taxes. As companies have grown to a global scale, the complexities of payroll transactions have risen. For example, an office in a first country may have employees that are taxed differently than an office in a second country, despite both offices being associated with a single company.

Often times, a particular geographic location (e.g., a country, a town, a city, etc.) has its own unique payroll engine that receives payroll information and performs payroll transactions. For example, a payroll engine may apply custom functions for calculating taxes, fees, credits, etc., specific to the geographic location. These payroll engines may request a universal change file (UCF) as an input, where the UCF includes a plurality of data values pertaining to one or more employees (e.g., name, address, role, etc.). However, depending on the payroll engine, some of the data may be unnecessary or may be formatted in a way that slows down the payroll transaction. For example, the payroll engine may be required to filter data that is relevant for a particular calculation, or may need to search for information in the UCF. This ultimately demands additional processing and increases latencies. The processing and latency issues are heightened when the UCF is missing key information or certain changes are required.

### SUMMARY

Aspects of the disclosure relate to the field of data storage In particular, aspects of the disclosure describe methods and systems for applying data transformations for payroll engines.

In one exemplary aspect, the techniques described herein relate to a system for processing payroll data, including: at least one memory; at least one hardware processor coupled with the at least one memory and configured, individually or in combination, to: identify a plurality of payroll engines for a company, wherein each respective payroll engine of the plurality of payroll engines is configured to process payroll transactions for employees in a unique geographic location of a plurality of geographic locations; for each respective payroll engine of the plurality of payroll engines: determine, from a plurality of data types, a respective subset of data types unique to the respective payroll engine and needed to process the payroll transactions based on the unique geographic location associated with the respective payroll engine; and determine a respective data format required by the respective payroll engine to process the payroll transactions; receive payroll data of an employee; in response to determining that the employee is associated with a first geographic location of the plurality of geographic locations, transform the payroll data corresponding to a first subset of data types into a first data format of the first geographic location; and transmit the payroll data transformed to a first payroll engine of the first geographic location.

In some aspects, the techniques described herein relate to a system, wherein the payroll data includes, for a respective employee, a plurality of changes applied to an employee profile, and wherein the at least one hardware processor is configured to transform the payroll data by: indicating each change of the plurality of changes by a timestamp; determining whether the respective payroll engine needs a latest change or the plurality of changes; and transforming the payroll data to include solely the latest change in response to determining that the respective payroll engine needs the latest change; or transforming the payroll data to include the plurality of changes in response to determining that the respective payroll engine needs the plurality of changes.

In some aspects, the techniques described herein relate to a system, wherein a change of the plurality of changes includes one or more of: an addition to the employee profile, a deletion from the employee profile, a modification to the employee profile.

In some aspects, the techniques described herein relate to a system, wherein the at least one hardware processor is further configured to transmit, to the respective payroll engine, the payroll data transformed in a change file.

In some aspects, the techniques described herein relate to a system, wherein processing the payroll transactions includes executing a function for calculating one or more of: taxes, salary, credits, and fees, wherein the function is specific to a legislative structure of the unique geographic location.

In some aspects, the techniques described herein relate to a system, wherein the payroll data includes one or more of: an employee name, an employee address, a job role, a salary, a frequency of pay, a contract length, a government-issued identifier, a company-issued identifier, an amount of dependents, years of experience.

In some aspects, the techniques described herein relate to a system, wherein the at least one hardware processor is configured to: determine, from the plurality of data types, the first subset of data types needed by the first payroll engine of the plurality of payroll engines; determine the first data format required by the first payroll engine to process a payroll transaction.

In some aspects, the techniques described herein relate to a system, wherein the at least one hardware processor is configured to: determine, from the plurality of data types, a second subset of data types needed by a second payroll engine of the plurality of payroll engines; determine a second data format required by the second payroll engine to process a payroll transaction.

In some aspects, the techniques described herein relate to a system, wherein the first subset of data types is different than the second subset of data types, and wherein the first data format is different than the second data format.

In some aspects, the techniques described herein relate to a system, wherein the at least one hardware processor is configured to transmit the payroll data to a first payroll engine of a first geographic location in response to determining that the payroll data is associated with one or more employees associated with the first geographic location.

In some aspects, the techniques described herein relate to a system, wherein the unique geographic location is one of a town, a city, a country, a continent, and a region.

In some aspects, the techniques described herein relate to a method for processing payroll data, including: identifying a plurality of payroll engines for a company, wherein each respective payroll engine of the plurality of payroll engines is configured to process payroll transactions for employees in a unique geographic location of a plurality of geographic locations; for each respective payroll engine of the plurality of payroll engines: determining, from a plurality of data types, a respective subset of data types unique to the respective payroll engine and needed to process the payroll transactions based on the unique geographic location associated with the respective payroll engine; and determining a respective data format required by the respective payroll engine to process the payroll transactions; receiving payroll data of an employee; in response to determining that the employee is associated with a first geographic location of the plurality of geographic locations, transforming the payroll data corresponding to a first subset of data types into a first data format of the first geographic location; and transmitting the payroll data transformed to a first payroll engine of the first geographic location.

In some aspects, the techniques described herein relate to a non-transitory computer readable medium storing thereon computer executable instructions for processing payroll data, including instructions for: identifying a plurality of payroll engines for a company, wherein each respective payroll engine of the plurality of payroll engines is configured to process payroll transactions for employees in a unique geographic location of a plurality of geographic locations; for each respective payroll engine of the plurality of payroll engines: determining, from a plurality of data types, a respective subset of data types unique to the respective payroll engine and needed to process the payroll transactions based on the unique geographic location associated with the respective payroll engine; and determining a respective data format required by the respective payroll engine to process the payroll transactions; receiving payroll data of an employee; in response to determining that the employee is associated with a first geographic location of the plurality of geographic locations, transforming the payroll data corresponding to a first subset of data types into a first data format of the first geographic location; and transmitting the payroll data transformed to a first payroll engine of the first geographic location.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for validating payroll data.

FIG. 2 is a diagram illustrating a graphical user interface (GUI) depicting the geographic region and various indicators associated with data validation.

FIG. 3 is a diagram illustrating the GUI depicting the geographic region and additional indicators associated with data validation.

FIG. 4 is a diagram illustrating the GUI depicting validation results for a plurality of employees.

FIG. 5 is a diagram illustrating the GUI depicting erroneous data values.

FIG. 6 is a block diagram illustrating a system for generating rules for geography-based data collection and evaluation.

FIG. 7 is a diagram illustrating the GUI depicting a plurality of data types associated with a geographic location.

FIG. 8 is a diagram illustrating the GUI depicting data type attributes.

FIG. 9 is a diagram illustrating the GUI depicting rule configuration and generation.

FIG. 10 is a block diagram illustrating a system for applying data transformations for payroll engines.

FIG. 11 is a diagram illustrating the GUI for showing data types associated with a data payroll engine associated with a geographic location.

FIG. 12 is a diagram illustrating the GUI for showing types of change files.

FIG. 13 is a diagram illustrating the GUI for configuring a change file.

FIG. 14 illustrates a flow diagram of a method for applying data transformations for payroll engines.

FIG. 15 illustrates a flow diagram of a method for applying data transformations based on selected configurations.

FIG. 16 presents an example of a general-purpose computer system on which aspects of the present disclosure can be implemented.

### DETAILED DESCRIPTION

Exemplary aspects are described herein in the context of a system, method, and computer program product for applying data transformations for payroll engines. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The present disclosure describes systems and methods for generating payroll change files (also referred to as partner change files (PCFs)) systematically for ingestion by different payroll engines. The PCF Framework is designed to solve the shortcomings of transmitting data to an interface for payroll engines to calculate gross to nets. The framework includes a configuration user interface that allows for the setup of a PCF by configuring the output formats, parameters, and interfaces for downstream processing. Output configuration includes variations such as showing all changes during a period, showing a final change during the period, and grouping changes and change rules.

In particular, the PCF framework supports both universal change files (UCFs) for in-country partners (ICPs) that do not have a downstream system interface for applying data transformations and ICPs that do have downstream systematic ingestion using a file format interface.

Conventional methods for providing data to payroll engines involve complex, individually managed extract-transform-load (ETL) processes for each customer or format, or complex, individually managed structured query language (SQL) logic for each customer or format. Both approaches have significant overhead in the designing, managing, and execution process. For example, complicated ETL tools need special developers in order to generate a change file from a database. This involves a long turnaround time involving communication between partners and ETL developers to make sure the input files are generated correctly. On the other hand, complex SQL logic places massive computational load on the database instances when generating an input file. This process not only slows down all other access to the databases, but takes an extremely long time and is subject to database thread starvation (e.g., time out).

Another approach for providing data to payroll engines involves manually altering XLS, CSV, and other manual file formats to transmit the employee changes to downstream payroll agents. This is also an efficient approach and scales very poorly as employee pools grow larger.

The framework of the present disclosure overcomes these shortcomings by allowing users to configure the PCF format in the system, pre-generate PCFs on changes so that the output time is minimal (e.g., in minutes rather than hours compared to the approaches described above), separate technology stacks that are custom picked, and design to support the PCF generation process, standalone services, message queues for changes, and unstructured databases.

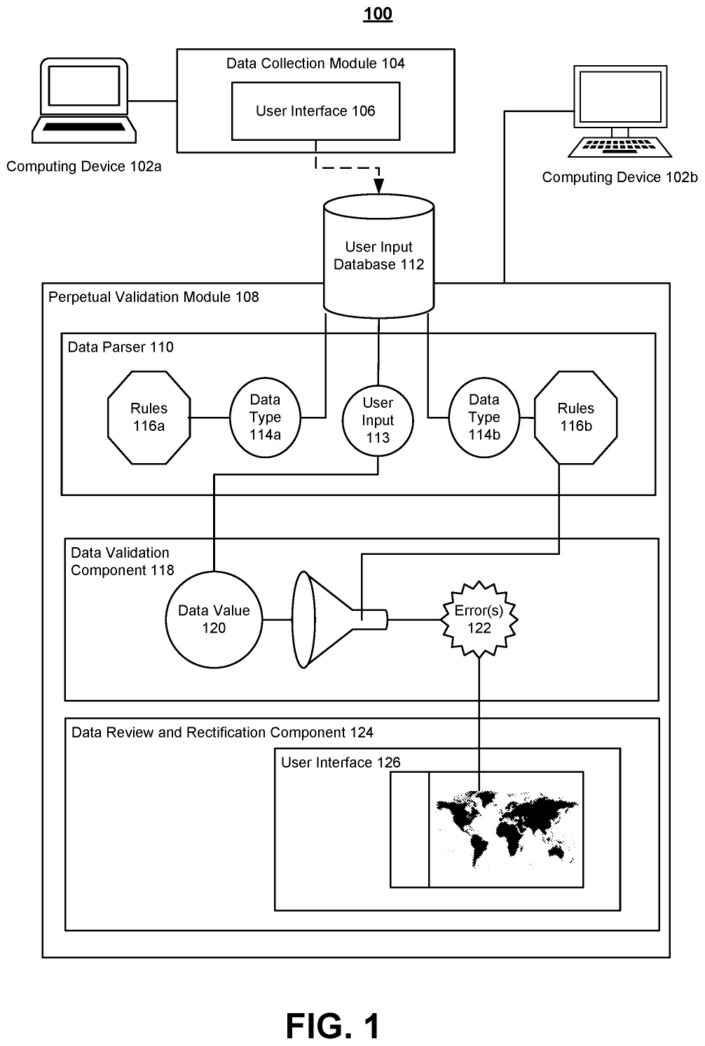

FIG. 1 is a block diagram illustrating a system 100 for validating payroll data. System 100 includes computing device 102a and computing device 102b. For example, computing device 102a may be a laptop, desktop, etc., of an employee and computing device 102b may be a laptop, desktop, server, etc., of a company that monitors payroll information.

Computing device 102a may execute data collection module 104, which includes a user interface 106. User interface 106 may enable an employee to input information about themselves. For example, user interface 106 may be an interface of a web application, a standalone application, a website, etc. User interface 106 may request the employee to input various data values to build an employee profile. Data values include, but are not limited to, name, address, job title, a government-issued identification number, date of birth, marital status, number of dependents, and emergency contact.

Data collection module 104 may be configured to upload the inputs gathered via user interface 106 to a user input database 112. In particular, user input database 112 may be configured and access via perpetual validation module 108. It should be noted that user input database 112 may receive the data values from a plurality of computing devices belonging to different employees. Each data collection module 104 of a respective computing device may be connected to user input database 112 via a network (e.g., a local area network, a wide area network, etc.).

In some aspects, perpetual validation module 108 may be an application split into a thick and thin client application. The thick client application may access user input database 112 and perform validation. In some aspects, the thick client application may be executed on a remote server. The thin client application may receive validation results and generate user interface 126 on computing device 102b.

In an exemplary aspect, data parser 110 retrieves data in user input database 112. For example, perpetual validation module 108 may receive a first user input that includes at least one data value associated with an employee of a company. Suppose that the company is an international retailer that has multiple offices throughout the world. For example, the company may have an office in a country (e.g., France) and another office in a different country (e.g., United States). Suppose that the first user input is associated with an employee from the United States. Accordingly, the at least one data value may include a name, an address, a marital status, and a social security number. The data values may be: “John Doe” as the name, “123 John Doe St., New York 10021” as the address, “single” as the marital status, and “123-45-56789 as the social security number.” It should be noted that the following examples provided are highly simplified for the sake of brevity and understanding. For example, the amount of data values received per user input may be quite large despite only four data values being given in the example.

It should also be noted that rather than be divided into countries/offices, employees may be divided into different pay groups (i.e., a group of employees paid at the same time). Each of those employees may be part of the same office or different offices.

The purpose of gathering these data values is to complete payroll transactions of the company in a given geographic location (e.g., a country). For example, an employee may provide the data values in order to enable a payback deposit in his/her bank account. The payroll transaction may need the data values for identification purposes and to perform calculations of taxation, fees, credits, salary, benefits, etc. For example, the person may have a bi-weekly paycheck deposit of $2000 and based on the information provided in the data values, the company may be able to determine the amount of tax the person owes (e.g., using marital status).

Because a company may be spread out across multiple geographic locations (e.g., cities, towns, states, provinces, countries, continents, etc.), the guidelines for performing payroll transactions may be different depending on the location of the office that the employee works in. For example, the tax rules in the United Kingdom may be different than the tax laws in the United States. Similarly, certain identifiers such as a social security number may be required in one country (e.g., the United States), but not in other countries that utilize a different identification system (e.g., a social insurance number that is used in Canada).

In a conventional approach, a user input is received and validation is not performed until a threshold number of user inputs have been received or when validation is manually launched (e.g., right before performing payroll transactions). This delayed/batch approach is inefficient because it can cause many payroll transactions to get delayed if multiple errors are detected. On a technical level, when validation is performed in one batch, a greater amount of computational resources are expended by a computing device in a short period of time. If a company has several thousands of employees, these shortcomings are exacerbated.

Accordingly, the systems and methods of the present disclosure perform data validation in real-time. For example, when a user enters data values using user interface 106, data collection module 104 may immediately upload the values to user input database 112. Perpetual validation module 108 may detect that user input database 112 has been updated and may be begin validation on the new data values received.

In an exemplary aspect, while receiving user input 113, perpetual validation module 108 validates the at least one data value (e.g., data value 120) of user input 113 in real-time. This involves first determining a data type of the at least one data value. For example, user input 113 may be [John Doe; 123 John Doe St., New York 10021; single; 123-45-56789]. For each data value, data parser 110 may identify one or more data types 114. For example, data type 114a may be “social security number.” The icons for types name, address, marital status, etc., are not shown in FIG. 1.

Each data type and geographic location may be linked to a plurality of localization rules 116. For example, rules 116a may be linked with data type 114a and the first geographic location (e.g., the location of the office or the residential location of the employee). Suppose that user input 113 is for an employee working in the United States. Rules 116a represent localization rule(s) associated with social security numbers in the United States.

It should be noted that the same data type may have different rules in different geographic locations. For example, data type 114b may also be social security number. However, if the geographic location is the United Kingdom, then data parser 110 retrieves rules 116b instead of rules 116a.

Localization rules establish certain criteria for a data value. For example, a rule may query the format of the data value. For example, a social security number is a 9-digit value that includes solely integers. Accordingly, one rule of rules 116a may indicate that the social security number must be nine digits. Other examples of localization rules may be: (1) the social security number cannot have symbols or letters; (2) the social security number should be formatted with 3 digits, followed by 2 digits, followed by 4 digits, (3) the social security number is only issued to persons that are citizens or permanent residents of the United States, etc.

From user input 113, data validation 118 may extract data value 120 (e.g., 123-45-56789) and assess the validity of the data value in view of the criteria of the plurality of localization rules 116a. For example, data validation component 118 may determine that the input social security number has 10-digits. Accordingly, data value 120 has an error 122. Suppose that in another data value, the employee indicated that he/she is not a citizen and is not a permanent resident. Based on the localization rules, this indicates that the employee should not have a social security number. Accordingly, the mere presence of the data value 120 would trigger an error. Errors 122 are provided to data review and rectification component 124, which generates and manages user interface 126.

In an exemplary aspects, data review and rectification component 124 generates, on user interface 126, an indication that the first user input requires review to complete the payroll transactions. In an exemplary aspects, user interface 126 displays a view of a geographical region and the indication is generated in a portion of the geographical region associated with the geographic location of the employee. In some aspects, the geographic location is a country and the geographic region is one or more continents.

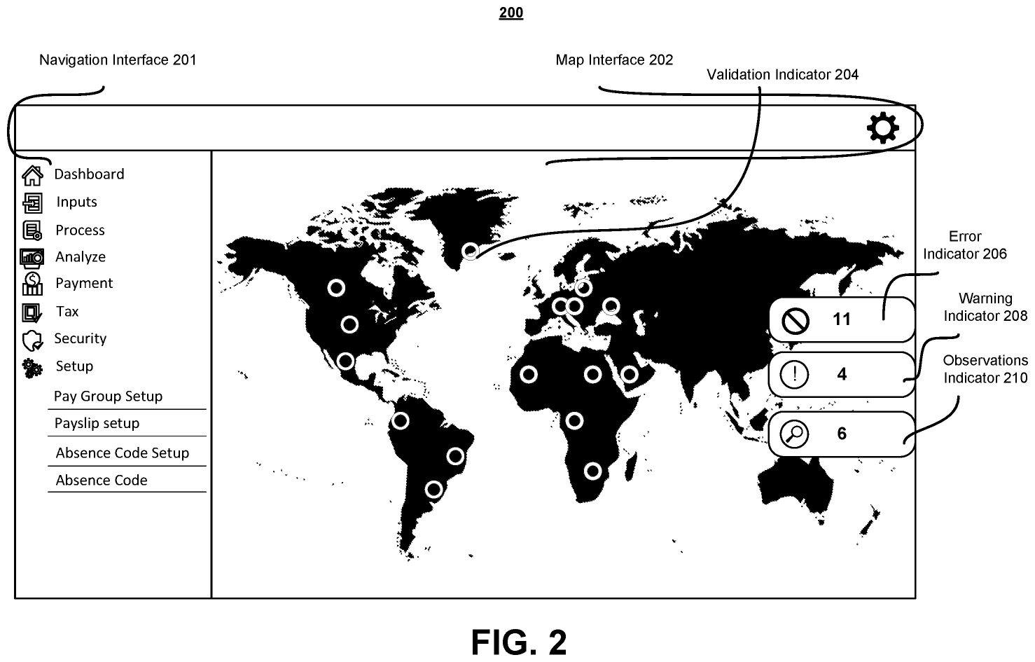

FIG. 2 is a diagram 200 illustrating a graphical user interface (GUI) depicting the geographic region and various indicators associated with data validation. For example, diagram 200 depicts user interface 126 wherein the geographic region includes continents of the world and the geographic locations are individual countries. User interface 126 includes a navigation interface 201, which is a menu that allows a user (e.g., a company payroll officer) to view different types of information and perform various functions. The buttons in navigation interface 201 include dashboard, inputs, process, analyze, payment, tax, security, and setup. A sub-menu of the setup button includes buttons for pay group setup, pay slip setup, absence code setup, and absence setup. When the dashboard button is selected, perpetual validation module 108 generates map interface 202.

User interface 126 depicts a plurality of indicators including validation indicator 204, error indicator 206, warning indicator 208, and observations indicator 210. When an employee provides a user input, perpetual validation module 108 validates the information and populates the indicators of use interface 126. For example, when an error is detected, the error count of error indicator 206 is incremented. When an error is resolved, the error count is decremented. As shown in FIG. 2, 11 errors are detected. When a warning is generated, the warning count of warning indicator 208 is incremented. While an error indicates that the invalid data value will prevent a payroll transaction from being completed, a warning indicates that the data value should be corrected even though it may not have an immediate negative affect on the payroll transaction. As an example, a social security number that has 10 digits may trigger an error, but a social security number for a non-citizen/non-permanent resident may trigger a warning. User interface 126 further has an observation indicator 210 that provides information about minor issues such as an incorrect data format (e.g., date should be Nov. 11, 2022 instead of 2022 Nov. 11). A user may select any of error indicator 206, warning indicator 208, and observations indicator 210 to view the erroneous data values, warned data values, and observed data values in a new window of user interface 126.

Validation indicator 204 is a marker generated on each geographic location associated with a given company. For example, a company may have 16 offices distributed over 16 countries. The employees from each office may provide data values for validation. In order to view the employee user inputs of a given geographic location, a user of map interface 202 may select validation indicator 204 of that geographic location.

In some aspects, validation indicator 204 may be represented by a shape such as a circle. In some aspects, validation indicator 204 may be color coded. For example, if a given office has more than a threshold amount of errors (e.g., 20% of entered data values), the indicator may be red. If a given office has less than the threshold amount of errors, the indicator may be green. Any number of visual effects (e.g., shading, textures, colors, etc.) and thresholds (e.g., 10%, 20%, etc.) can be applied to a validation indicator 204. The purpose is to allow the user to highlight the areas that are in immediate need of review.

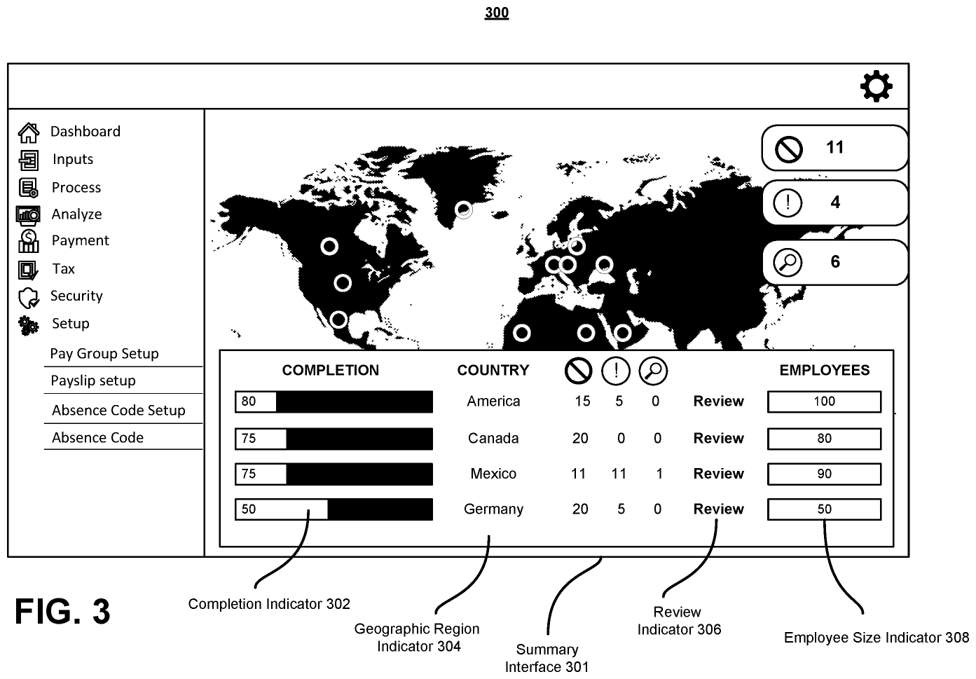

FIG. 3 is a diagram 300 illustrating the GUI depicting the geographic region and additional indicators associated with data validation. In addition to validation indicators, a user may opt to view a summary interface 301. Summary interface 301 lists each of the geographic locations (using geographic region indicator 304) and enables the user to view the individual errors, warnings, and observations counts of the geographic locations. Perpetual validation module 108 may also add a review indicator 306 to each of the items on the list to allow the user to navigate to a new window detailing the data values specific to that geographic location (errors, warnings, observations). In some aspects, summary interface 301 includes an employee size indicator 308 that lists the amount of unique employees in each geographic location. Each of these employees may provide user inputs to generate employee profiles. Completion indicator 302 provides an amount (e.g., percentage) of employee profiles that have no errors/warnings and do not need corrections.

For example, in FIG. 3, Canada has a completion rate of 75% which suggests that 75% of the 80 employees have entered fully valid data and have complete employee profiles (e.g., no errors). This means that 60 employees have entered data correctly and 20 have not. According to summary interface 301, all of those 20 employees have errors in their data values. Referring to Germany, which has 50 employees and a 50% completion rate, summary interface 301 indicates that 25 of the employee rates that remain to be completed include 20 with errors and 5 with warnings.

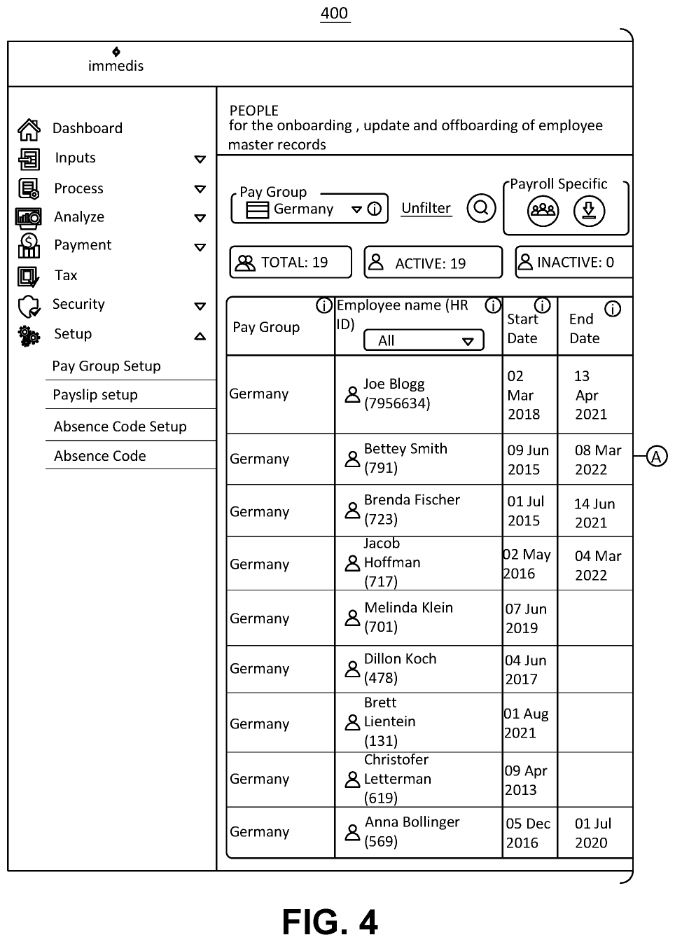

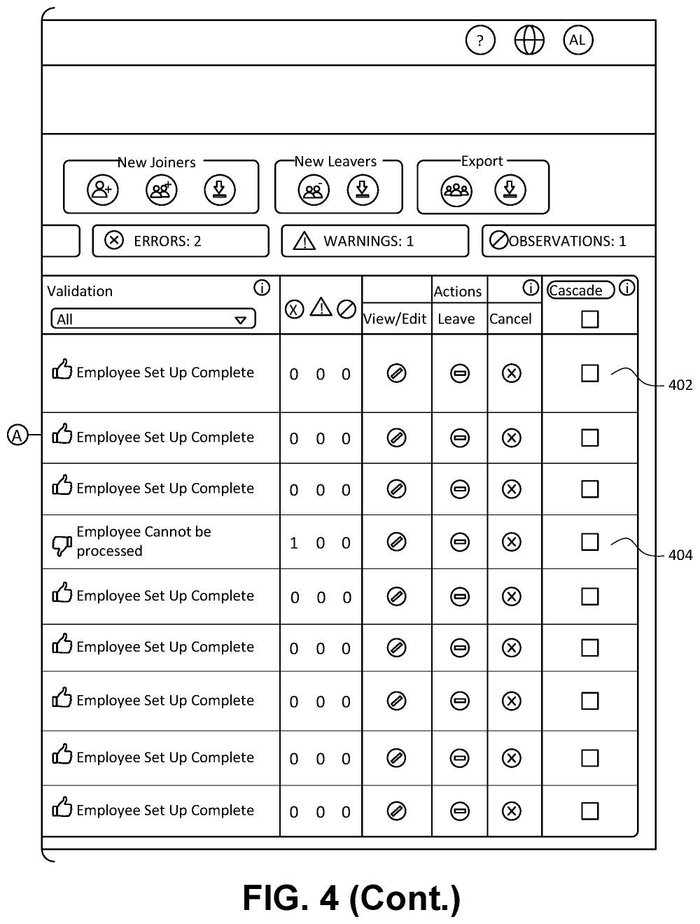

FIG. 4 is a diagram 400 illustrating the GUI depicting validation results for a plurality of employees. Suppose that a user selects the validation indicator 204 of Germany or review indicator 306 of Germany. In response to the selection, perpetual validation module 108 may generate a window that lists a plurality of employee profiles. For example, the first employee is Joe Blogg whose employee identification number is 7956634. The validation results state “employee set up complete,” which indicates that Joe has entered data values that are valid and can be processed for payroll transactions. The entry for Joe is an example of a valid entry 402. In contrast, the fourth entry (e.g., Jacob Hoffman) has a validation result “employee cannot be processed.” The tally columns suggest that there are three errors and one warning in Jacob's employee profile. A user may select the “view/edit” option in Jacob's row to view the employee profile. The entry for Jacob is an example of an invalid entry 404.

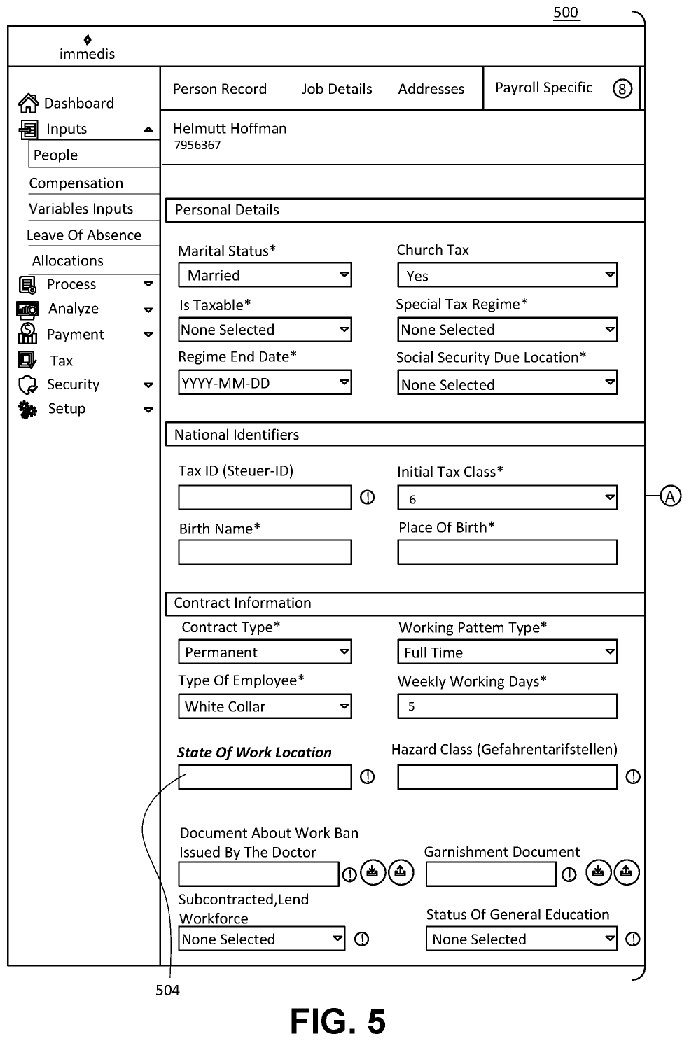

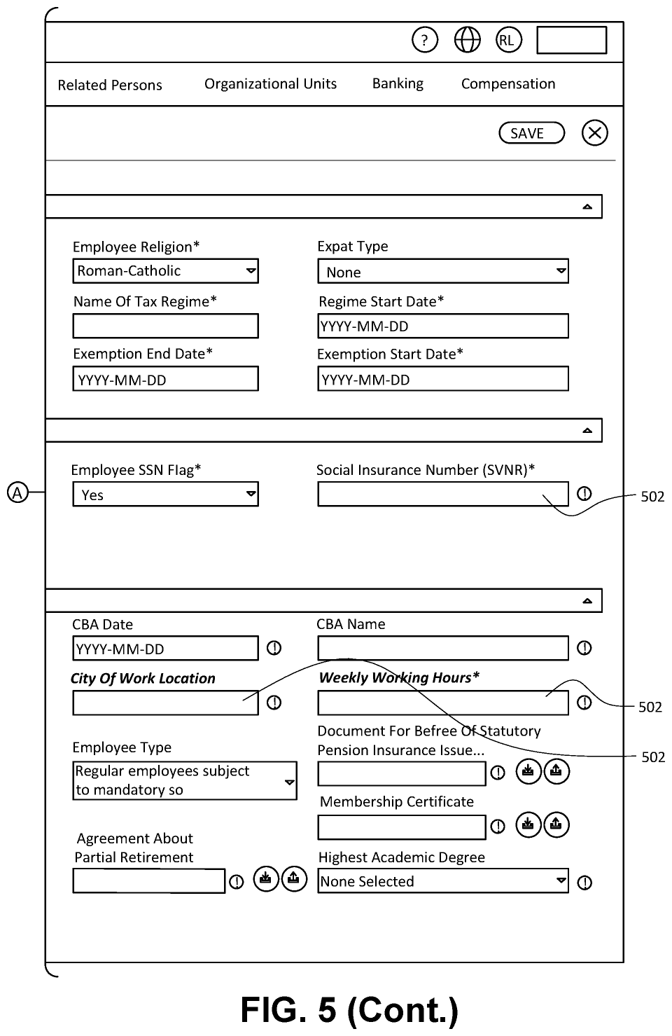

FIG. 5 is a diagram 500 illustrating the GUI depicting erroneous data values. FIG. 5 depicts a window of user interface 126 that is generated when the user selects the “view/edit” option in invalid entry 404. As can be seen, there are several data values collected from the employee. These data values include personal details (e.g., marital status, religion, etc.), national identifiers (e.g., Tax ID, Tax Class, social security number, etc.), and contract information (e.g., contract type, working days, work location, employee type, etc.).

Invalid entry 404 is generated because the employee failed to provide a social security number, city of work location, and weekly working hours. These are marked as error fields 502. In addition, there is a warning generated because the employee failed to provide a state of work location. This is marked as warning field 504. In some aspects, the error fields are visually marked/highlighted by an error icon or a color associated with error (e.g., red). In some aspects, the warning fields are visually marked/highlighted by a warning icon or a color associated with error (e.g., yellow).

It should be noted that the interface shown in FIG. 5 includes additional tabs on the top portion of the window (e.g., person record, job details, addresses, payroll specific, related persons, organizational units, banking, and compensation). A user may select one of these tabs to view that information about the employee. For example, the banking tab may be linked to a window that displays banking information (e.g., bank, account number, routing number, etc.). Errors, warnings, and observations may also be generated based on those data values. For example, if a user provides a routing number that is not linked to a bank, perpetual validation module 108 may generate validation results that highlight the erroneous routing number.

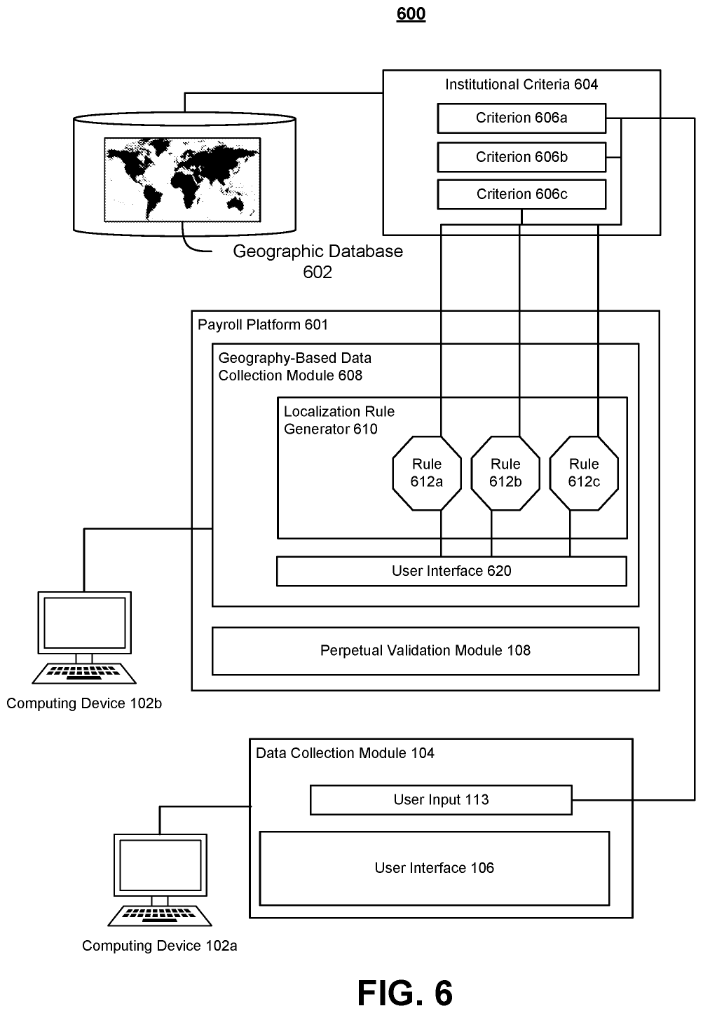

FIG. 6 is a block diagram illustrating a system 600 for configuring rules for geography-based data collection and evaluation. System 600 includes payroll platform 601, which is made up of geography-based data collection module 608, which may execute the CSI framework mentioned previously, and perpetual validation module 108. Geography-based data collection module 608 receives institutional criteria 604 for processing payroll transactions for employees in a first geographic location (e.g., a country such as the United States). The institutional criteria may be unique to the first geographic location from a plurality of geographic locations in geographic database 602. For example, geographic database 602 may list several countries and their individual criterion 606a, 606b, 606c, etc. It should be noted that although only three criterion are shown in FIG. 6, a particular geographic location may have hundreds or thousands of criterion. As laws change in a particular geographic location, geographic database 602 may be manually updated to incorporate new institutional criteria 604.

Geography-based data collection module 608 parses institutional criteria 604 and identifies from a plurality of data types, a subset of data types that correspond to the institutional criteria 604. For example, criterion 606a may be a government-issued identifier such as a social security number. Criterion 606a may also list various attributes of the social security number as metadata. For example, the attributes may indicate that the social security number is nine digits long, is solely numerical, is possessed by US citizens and permanent residents, etc. Criterion 606b may be a date of birth. The attributes of criterion 606b may include that the employee cannot be less than 18 years of age, the date of birth cannot be past the current date, etc. Criterion 606c may be a marital status. The attributes of criterion 606c may indicate that the marital status may be one of: single, married, separated, widowed, divorced, etc. Geography-based data collection module 608 may refer to plurality of data types (e.g., data type 114a, 114b, etc.) to determine a matching data type to the criterion. For example, the plurality of data types may be stored in the memory of the computing device 102b and may include social security number, date of birth, and marital status. In response to determining matches (e.g., by text comparison), geography-based data collection module 608 may identify a subset of data types that correspond to institutional criteria 604. If a match for data type cannot be identified, a new data type may be created by geography-based data collection module 608.

Subsequently, geography-based data collection module 608 generates, using localization rule generator 610, at least one localization rule that assesses whether the institutional criteria 604 is satisfied. For example, geography-based data collection module 608 may generate rule 612a for criterion 606a, rule 612b for criterion 606b, and rule 612c for criterion 606c. These rules may specifically stem from the metadata accompanying institutional criteria 604. For example, rule 612a may be associated with the social security number being a nine digit numerical value. For example, rules 612a, 612b, 612c correspond to rules 116a described previously.

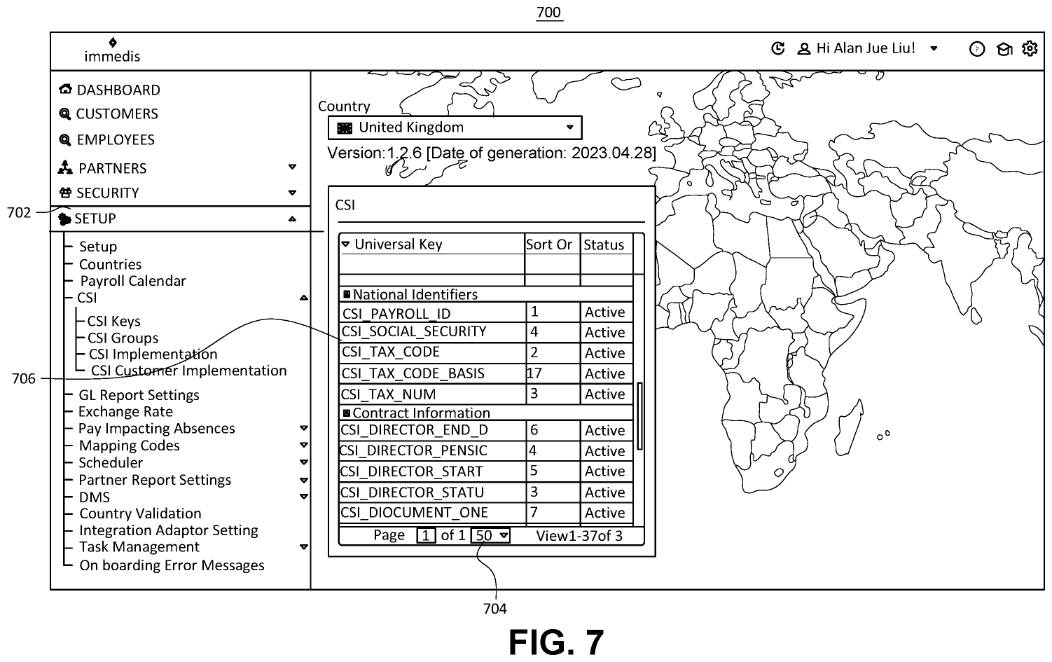

In some aspects, a user of geography-based data collection module 608 may generate and configure rules using user interface 620 of geography-based data collection module 608. Examples of snapshots of user interface 620 are shown in FIGS. 7-9.

Geography-based data collection module 608 may further generate a graphical user interface 106 that receives data input from an employee via computing device 102a. For example, geography-based data collection module 608 may transfer data entry fields associated with the subset of data types corresponding to institutional criteria 604. In particular, geography-based data collection module 608 may determine whether data collection module 104 is being accessed by an employee in a particular geographic location. In response, geography-based data collection module 608 may configure data collection module 104 to display, from a plurality of data entry fields, solely fields associated with the subset of data types on the graphical user interface 106. Subsequently, in response to receiving at least one entry (i.e., user input 113) in the fields associated with the subset of data types, perpetual validation module 108 may validate the at least one entry using the at least one rule generated by geography-based data collection module 608 (e.g., rule 612a to assess the data type entry corresponding to criterion 606a). The validation process is described in the description of FIG. 1 and will not be recited again for the sake of brevity.

Geography-based data collection module 608 may then generate, on the graphical user interface 106, an error message in response to determining that the at least one entry does not satisfy the institutional criteria 604 of the geographic location associated with the employee. It should be noted that geography-based data collection module 608 may be implemented as a thick client application that runs on computing device 102b, parses criteria, generates rules, and enables rule configuration via user interface 620. Geography-based data collection module 608 may also be implemented as a thin client application that generates user interface 106 based on the data types associated with institutional criteria 604 and receives user input 113. The thin client application may transmit user input 113 for validation by perpetual validation module 108.

In reference to FIGS. 7-9, diagrams 700, 800, and 900 may be snapshots of user interface 620. In some aspects, user interface 620 and user interface 126 are part of the same graphical user interface.

FIG. 7 is a diagram 700 illustrating the GUI depicting a plurality of data types associated with a geographic location. In order to the window shown in diagram 700, a user may select the rule setup 702 option in the side panel (i.e., navigation interface). Upon selection, geography-based data collection module 608 generates data type window 704, which lists a plurality of data types 706 for a particular geographic location (e.g., the United Kingdom). For example, one data type may be CSI_TAX_CODE, which is a national identifier. In some aspects, certain data types may be inactive depending on whether the criteria is still relevant in the geographic location. For example, a law may change, which causes a data type that is currently active to be made inactive.

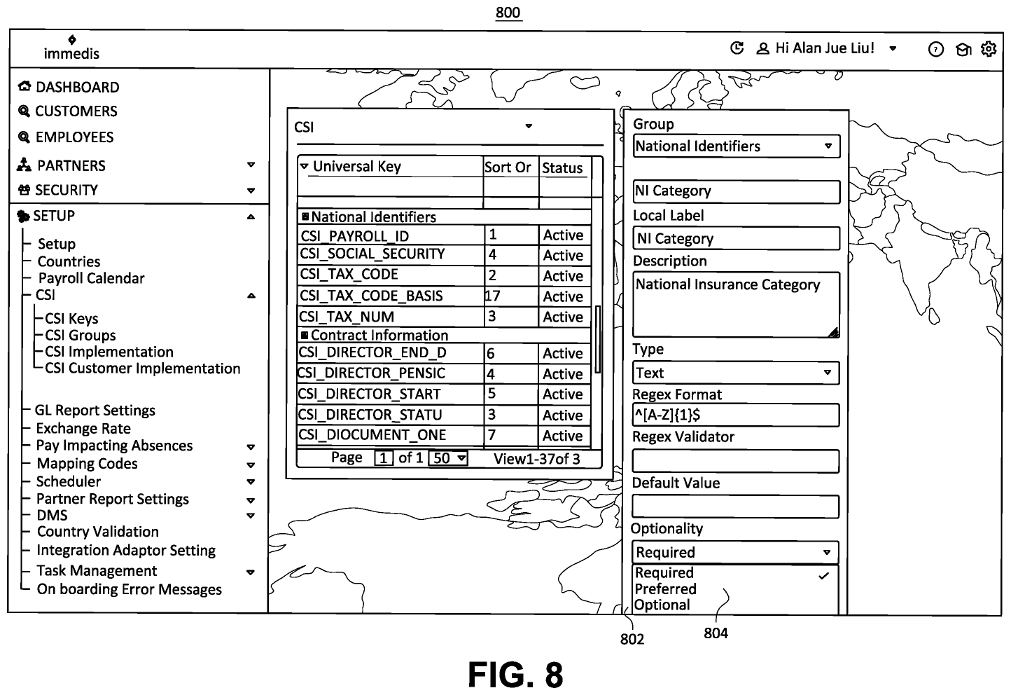

FIG. 8 is a diagram 800 illustrating the GUI depicting data type attributes. For example, a user may select the data type “CSI_SOCIAL_SECURITY,” which generates data type attribute window 802, which lists configurable attributes such as group, global label, local label, etc. Selecting one of the configurable attributes may generate options 804, which lists the possible parameters that a parameter can take. For example, in terms of “optionality,” options 804 lists the following parameters in a dropdown menu: required, preferred, optional.

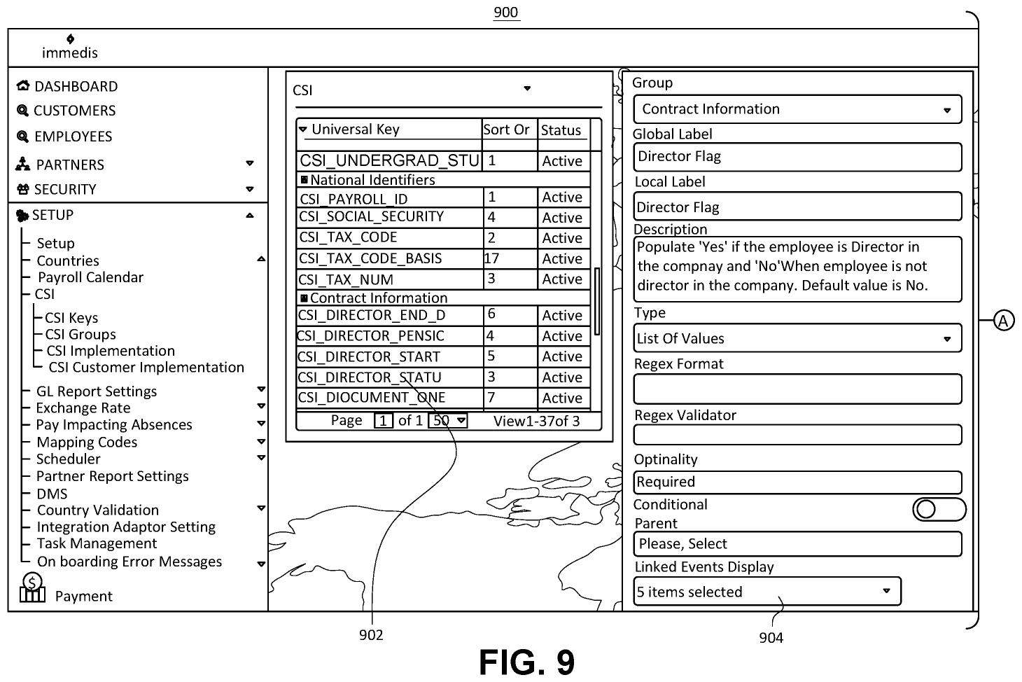

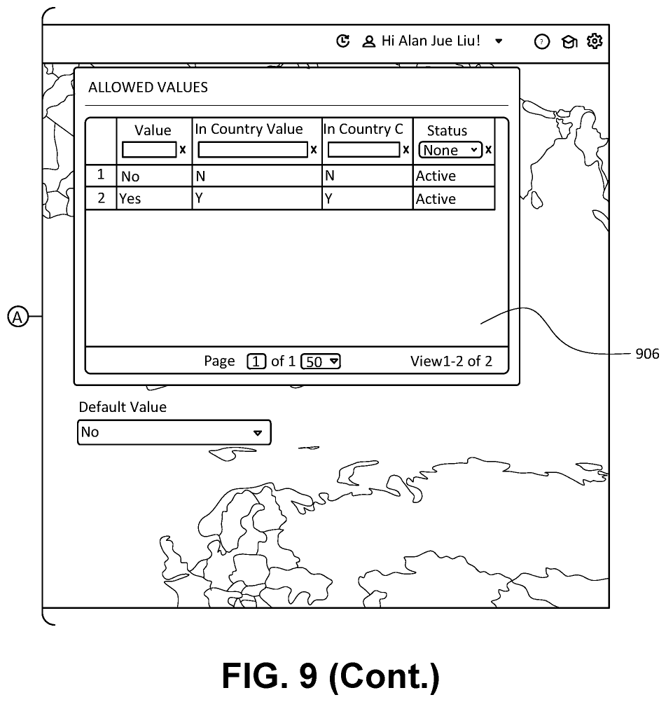

FIG. 9 is a diagram 900 illustrating the GUI depicting rule configuration and generation. Suppose that the selects data type 902 (i.e., CSI_DIRECTOR_STATUS). In response, geography-based data collection module 608 generates data type attributes window 904, which lists various attributes and parameters. One of the options in data type attributes window 904 is to set rules associated with data type 902. For example, rule 906 indicates that an employee can select either yes or no as the director status (i.e., the person is a director or is not). In some aspects, there may be a rule that a given company/office may only have one director. Accordingly, if more than one employees indicate “yes,” an error may be raised by perpetual validation module 108.

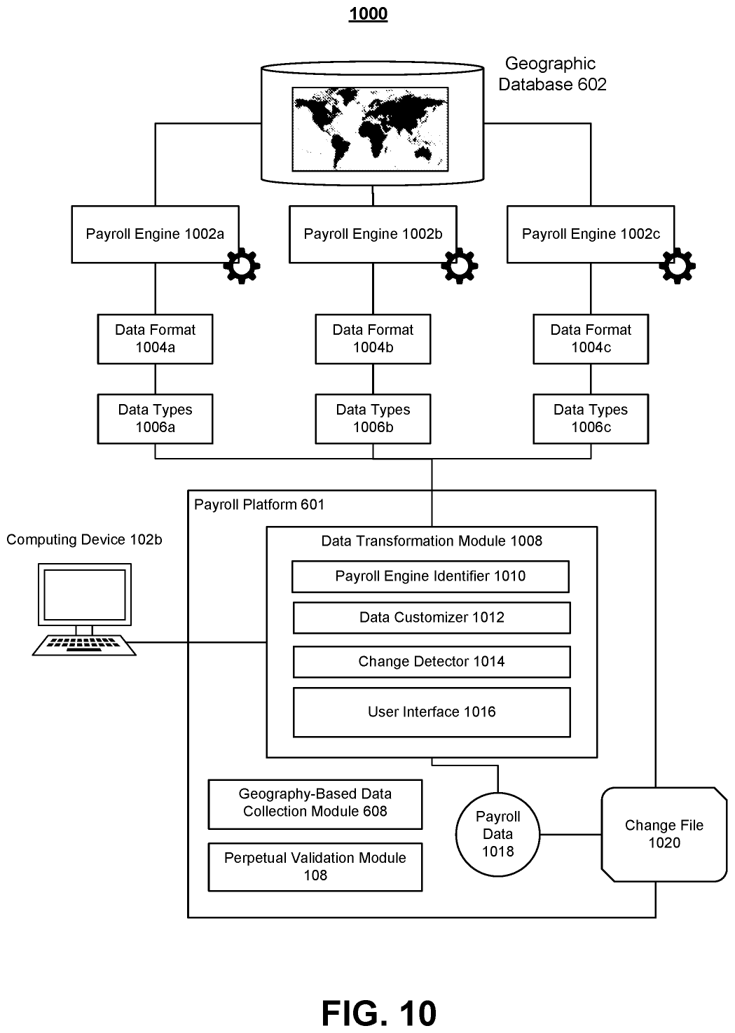

FIG. 10 is a block diagram illustrating a system 1000 for applying data transformations for payroll engines. System 1000 includes data transformation module 1008 that runs on computing device 102b and is used to transform payroll data 1018 to produce change file 1020. In an exemplary aspect, data transformation module 1008 is part of payroll platform 601, which further includes geography-based data collection module 608 and perpetual validation module 108. While geography-based data collection module 608 is configured to identify the data to collect for a particular location (e.g., based on the laws of the geographic location) and perpetual validation module 108 is configured to validate the information provided by the employee, data transformation module 1008 is configured to take the validated payroll data and deliver it to payroll engines for the execution of payroll transactions.

Whenever a new employee profile is generated, modified, or deleted, data transformation module 1008 may apply transformations on payroll data 1018 to generate change file 1020, which is processed by a payroll engine to execute one or more payroll transactions. While certain change files have a universal format, certain geographic locations (e.g., countries, states, provinces, cities, towns, etc.) use one or more payroll engines 1002a, 1002b, and 1002c. Although only three payroll engines are shown, one skilled in the art will appreciate that any number of payroll engines may be utilized throughout the world.

Geographic database 602 includes geographic-based information (e.g., data types, rules, etc.) associated with a plurality of geographic locations. Geographic database 602 also lists which payroll engine(s) are used in a geographic location, each payroll engines required data types and data format. For example, payroll engine 1002a may be listed to require data types 1006a in data format 1004a, payroll engine 1002b may be listed to require data types 1006b in data format 1004b, and payroll engine 1002c may be listed to require data types 1006c in data format 1004c. Suppose that payroll engine 1002a is used in the United States, payroll engine 1002b is used in the United Kingdom, and payroll engine 1002c is used in Germany.

Payroll engine identifier 1010 of data transformation module 1008 is configured to identify a plurality of payroll engines for a company. Payroll engine identifier 1010 may refer to geographic database 602 for this information.

For each respective payroll engine (e.g., payroll engine 1002a) of the plurality of payroll engines (e.g., payroll engine 1002a-c), payroll engine identifier 1010 determines, from a plurality of data types (e.g., 1006a, 1006b, 1006c), a respective subset of data types unique to the respective payroll engine and needed to process the payroll transactions based on the unique geographic location associated with the respective payroll engine. For example, data types 1006a may include: name, office address, bi-weekly salary, dependent counts, and job title. Data types 1006b may include: name, residential address, monthly salary, and marital status. Data types 1006b may include: name, residential address, bi-weekly salary, hours worked, number of vacation days, etc.

Payroll engine identifier 1010 may then determine, using geographic database 602, a respective data format required by the respective payroll engine to process the payroll transactions. For example, data format 1004a may indicate that change file 1020 should list data types in one column and information in rows, should be sent to payroll engine at a particular time in a timeframe (e.g., every Monday in the week), should be in a Microsoft Excel™ file, should be organized in the following order: name, job title, bi-weekly salary, dependent counts, office address, etc.

Suppose that data transformation module 1008 is to generate change file 1020 for payroll engine 1002a. Data transformation module 1008 may identify one or more employees that are associated with the first geographic location (e.g., work or live in the United States) and populate their relevant information into change file 1020. In particular, change detector 1014 may detect changes in employee profiles (e.g., generation of new profiles, modifications to existing profiles, deletions of profiles, etc.) and may pull the changed data as payroll data 1018 to report to payroll engine 1002a. Data customizer 1012 of data transformation module 1008 may transform the payroll data 1018 corresponding to a first subset of data types 1006a into a first data format 1004a of the first geographic location. These transformations may include, but are not limited to, adding/removing columns, adding/removing rows, swapping data in one location with another location, rotating the file such that the columns become rows, applying a multiplier on numerical values in the file, annualizing salaries, removing characters that are not alphabets or numbers (e.g., removing symbols), translating the language in the file, and applying money conversion (e.g., from dollars to rupees).

Data transformation module 1008 may then transmit the payroll data 1018 transformed to payroll engine 1002a (e.g., more specifically to the computing device that runs payroll engine 1002a).

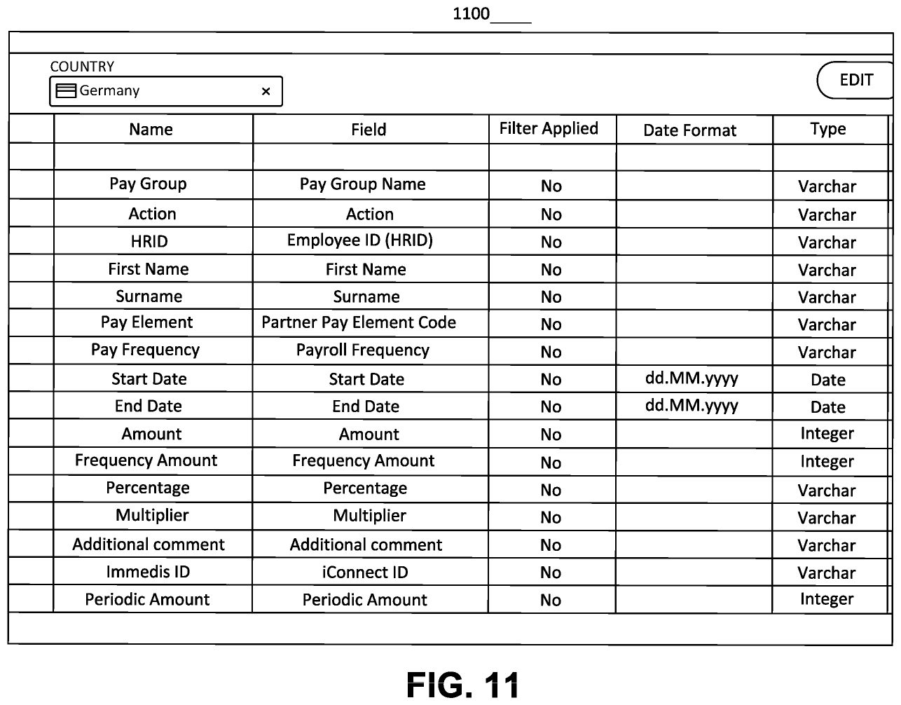

In an exemplary aspect, data transformation module 1008 is configured to generate user interface 1016. FIGS. 11-13 represent snapshots of user interface 1016. In some aspects, user interface 1016, user interface 620, and user interface 126 are all part of the same user interface that is executed and displayed on computing device 102b.

FIG. 11 is a diagram 1100 illustrating the GUI for showing data types associated with a data payroll engine associated with a geographic location. For example, the selected geographic location is Germany in diagram 1100. The required data types of Germany are listed and include pay group, action, employee identifier, first name, surname, etc. For the listed data types, diagram 1100 displays the data format in which the data types should be structured. For example, the order of the list indicates the order in which the payroll data should be provided. In addition, diagram 1100 indicates whether a filter should be applied (e.g., a translation, a conversion, etc.) to a data type, the format for dates, the type of data values (e.g., varchar, date, integer, etc.). A user may alter, using the edit button on the top right of user interface 1016, each of these fields by adding/modifying data.

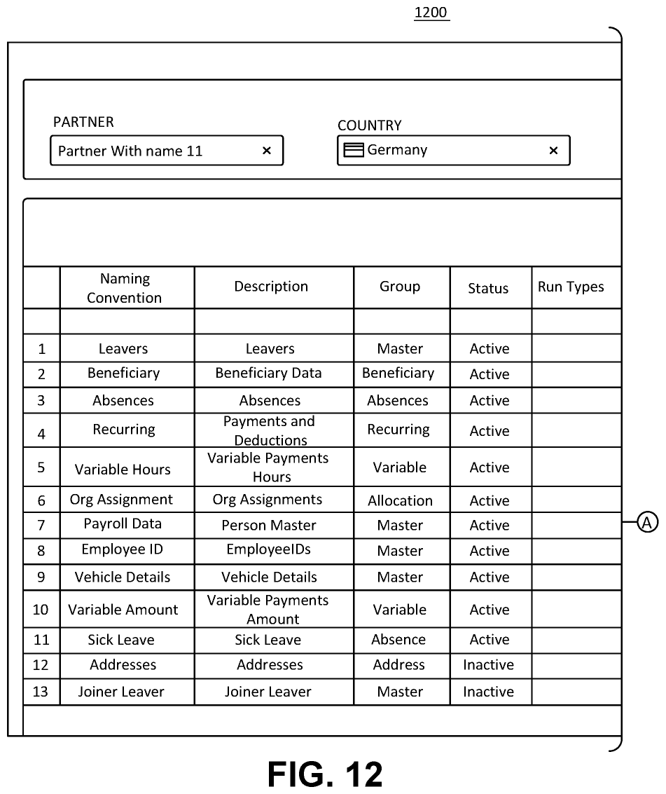

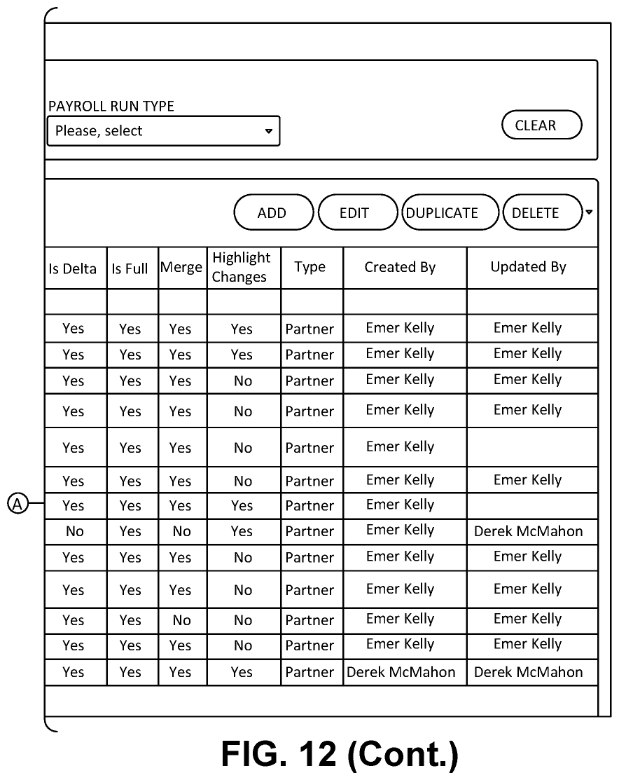

FIG. 12 is a diagram 1200 illustrating the GUI for showing types of change files. For example, there may be different change files for different types of data offered in a employee profile. In some aspects, these types of data include payroll data, beneficiary data, absences, sick leaves, addresses, etc. Referring to FIG. 12's payroll data option, diagram 1200 indicates that the group of the payroll data is master, the status is active, the delta is active, the payroll data is full, merge is active, changes are to be highlighted, the change file type is partner (e.g., specific to a payroll engine rather than a universal payroll engine), and was created by a user named “Emer Kelly.” In general, payroll data master indicates the use of the master payroll data (e.g., there may be different groups to track the data such as Master (employee changes), Variable, Recurring, Absence, Address). Status indicates whether the file is active or inactive. IsDelta indicates whether to provide changes or the complete payroll data of an employee. IsFull indicates whether to display a full line for each employee or just show each field that has changed. Highlight changes indicates whether to add a distinguishing color (e.g., yellow) in each cell that has a change. Merge indicates merging the file into one file as a separate tab within the file. Merge master indicates a filename to use when merging into one tab with one file (e.g., a universal change file). Merge group enables merging of multiple files and multiple merged tabs.

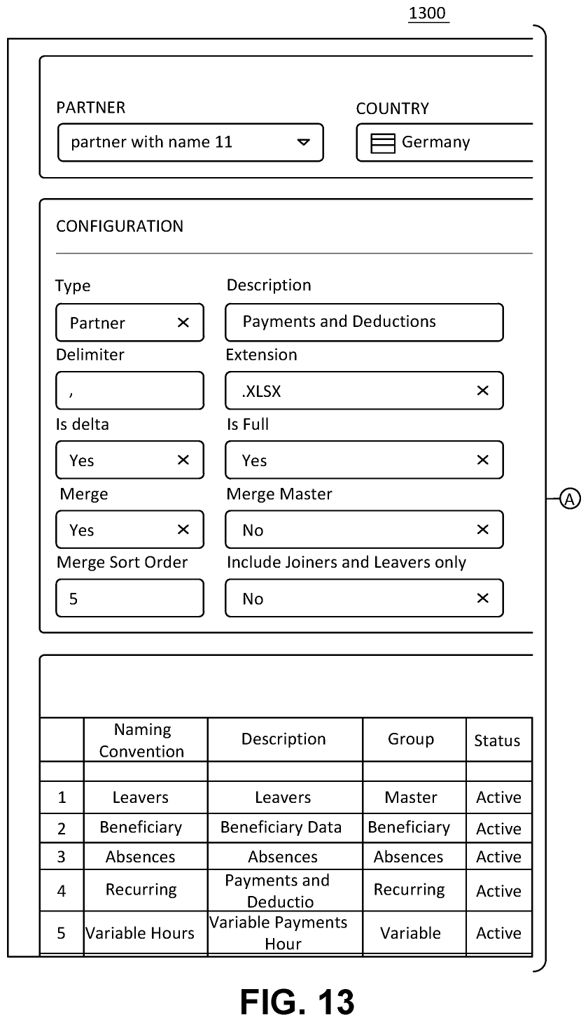

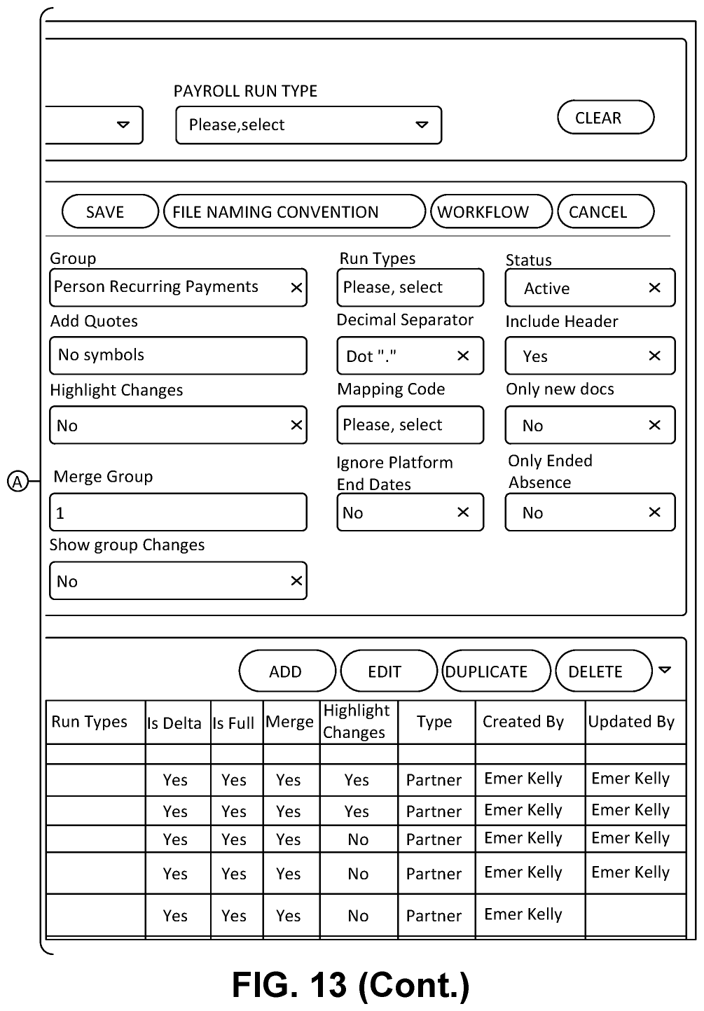

FIG. 13 is a diagram 1300 illustrating the GUI for configuring a change file. In diagram 1300, the selected geographic location is Germany. Accordingly, the change file is being generated for a payroll engine in Germany. As depicted, a user may select a type of the change file (e.g., partner or universal), provide a description (e.g., payments and deductions), indicate a delimiter, an extension of the change file (e.g., .xlsx), a group, a status, etc. This information may be stored in the types of change files shown below the configuration window.

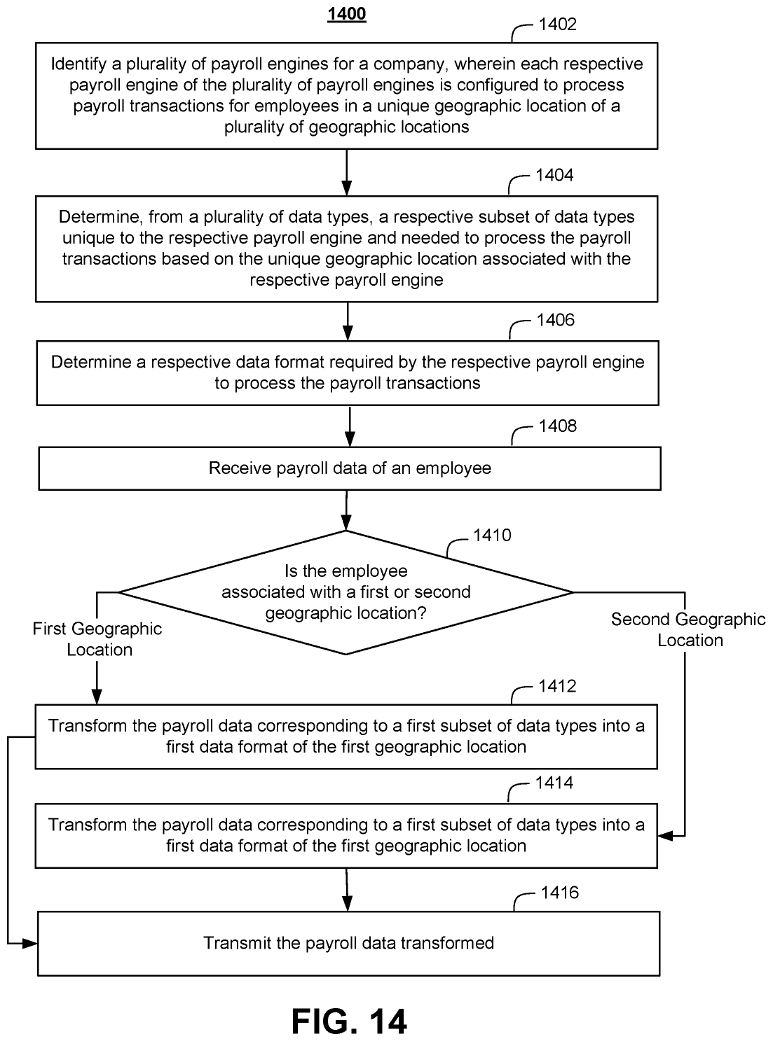

FIG. 14 illustrates a flow diagram of a method 1400 for applying data transformations for payroll engines. At 1402, data transformation module 1018 identifies, via payroll engine identifier 1010, a plurality of payroll engines for a company. For example, a company may have offices in a plurality of locations around the world and each location may have one or more payroll engines. Referring to FIG. 10, data transformation module 1018 may retrieve information about each payroll engine from geographic database 602, which lists the engines 1002a, 1002b, 1002c, etc. As mentioned before, each respective payroll engine 1002 of the plurality of payroll engines is configured to process payroll transactions for employees in a unique geographic location of a plurality of geographic locations. In some aspects, processing the payroll transactions comprises executing a function for calculating one or more of: taxes, salary, credits, and fees. The function is specific to a legislative structure of the unique geographic location. For example, a function for calculating taxes may need information such as residential address, marital status, and salary (only mentioning three data types for simplicity) for one geographic location. In contrast, for a different geographic location, the function for calculating taxes may further require an amount of dependents associated with the employee in addition to the three data types mentioned above.

Steps 1404 and 1406 are repeated for each respective payroll engine of the plurality of payroll engines. At 1404, data transformation module 1018 determines, from a plurality of data types, a respective subset of data types unique to the respective payroll engine and needed to process the payroll transactions based on the unique geographic location associated with the respective payroll engine. At 1406, data transformation module 1018 determines a respective data format required by the respective payroll engine to process the payroll transactions.

For example, data transformation module 1018 may determine, from the plurality of data types, the first subset of data types 1006a needed by the first payroll engine 1002a of the plurality of payroll engines. Data transformation module 1018 may also determine the first data format 1004a required by the first payroll engine 1002a to process a payroll transaction.

Then, data transformation module 1018 may determine, from the plurality of data types, a second subset of data types 1006b needed by a second payroll engine 1002b of the plurality of payroll engines. Data transformation module 1018 may also determine a second data format 1004b required by the second payroll engine 1002b to process a payroll transaction.

In this example, the first subset of data types 1006a is different than the second subset of data types 1006b, and the first data format 1004a is different than the second data format 1004b.

At 1408, data transformation module 1018 receives payroll data 1018 of an employee. In some aspects, the payroll data 1018 comprises one or more of: an employee name, an employee address, a job role, a salary, a frequency of pay, a contract length, a government-issued identifier, a company-issued identifier, an amount of dependents, years of experience.

At 1410, data transformation module 1018 determines whether the employee is associated with a first geographic location or a second geographic location. In response to determining that the employee is associated with the first geographic location, method 1400 advances to 1412. In response to determining that the employee is associated with the second geographic location, method 1400 advances to 1414.

At 1412, data transformation module 1018 transforms, via data customizer 1012, the payroll data 1018 corresponding to a first subset of data types into a first data format of the first geographic location. At 1414, data transformation module 1018 transforms the payroll data 1018 corresponding to a second subset of data types into a second data format of the second geographic location.

Suppose the complete file of employee profile has the following payroll data 1018 and data types:

TABLE 1
Employee Profile

| | Employee | | | | | | |
|---|---|---|---|---|---|---|---|
| | Identifier | | Marital | Amount of | | | |
| Name | Number | Address | Status | Dependents | Salary | . . . | Citizenship |
| John | 123-123 | 9999 | Single | 2 | $80000 | . . . | US |
| Doe | | John St. | | | | | |
| | | New | | | | | |
| | | York, | | | | | |
| | | 10031 | | | | | |

Suppose that data transformation module 1018 determines, based on the address of the employee, that the employee is associated with the geographic location, United States. United States may employee payroll engine 1002a. Data types 1006a of payroll engine 1002a may be: name, address, marital status, salary. Data Format 1004a may indicate that the information of an employee should be provided in a comma separated value (CSV) file, with columns order as: name, salary, marital status, and address. Accordingly, the transformations applied to the payroll data 1018 (e.g., the complete file) may involve removing certain columns that do not match the required data types 1006a and shuffling the data types in the required data format 1004a.

From 1412 and 1414, method 1400 advances to 1416, where data transformation module 1018 transmits the transformed payroll data 1018. For example, if the employee is associated with the first geographic location, data transformation module 1018 transmits the transformed payroll data 1018 to the first payroll engine of the first geographic location. If the employee is associated with the second geographic location, data transformation module 1018 transmits the transformed payroll data 1018 to a second payroll engine of the second geographic location. In some aspects, a payroll engine may be implemented on a server that is different than computing device 102b. The server of the payroll engine may receive the transformed payroll data 1018 and execute a payroll transaction.

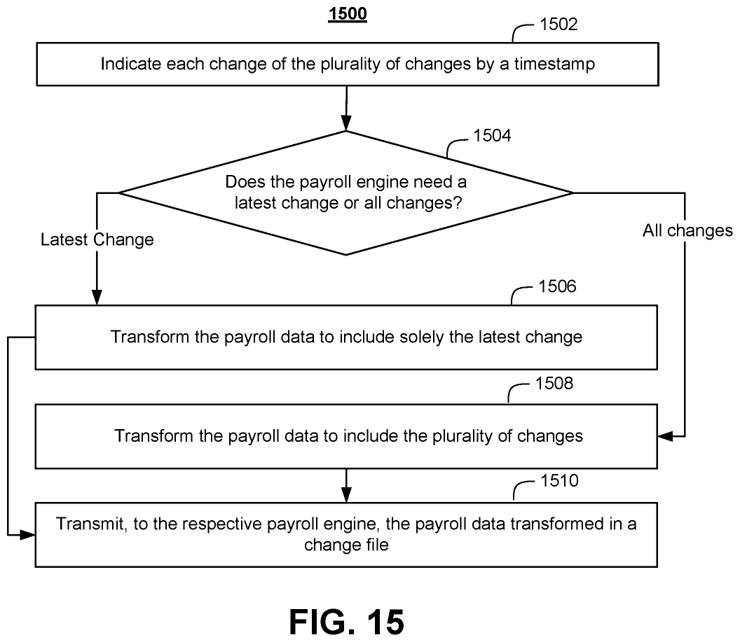

FIG. 15 illustrates a flow diagram of a method 1500 for applying data transformations based on selected configurations. In some aspects, the payroll data 1018 comprises, for a respective employee, a plurality of changes applied to an employee profile. For example, when an employee profile is first generated, it may have several data values that change over time. These data values may include, but are not limited to, salary, dependents, address, citizenship status, etc. Some data values are more likely to change than others. For example, an employee may receive a yearly promotion, but the job title of the employee may remain the same. In some aspects, a change of the plurality of changes includes one or more of: an addition to the employee profile, a deletion from the employee profile, a modification to the employee profile.

When transforming the payroll data 1018, at 1502, data transformation module 1018 indicates each change of the plurality of changes by a timestamp. For example, data transformation module 1008, via change detector 1014, may determine that on Jan. 1, 2022 12:00 am, the employee's salary changed from $80 k to $90 k. Subsequently on Jan. 1, 2023 12:00 am, the employee's salary changed from $90 k to $100 k. In particular, change detector 1014 may intercept each change to the employee profiles stored for a company and record the time of change.

At 1504, data transformation module 1018 determines whether the respective payroll engine needs a latest change or the plurality of changes. For example, data format 1004a may indicate that whenever a change is made, a change file 1020 indicating the change should be transmitted to payroll engine 1002a. In response to determining that the respective payroll engine needs the latest change, method 1500 advances to 1506, where data transformation module 1018 transforms the payroll data 1018 to include solely the latest change. Referring to the employee profile in table 1, suppose that the salary of the employee has changed, change file 1020 may include the following data: name, latest salary, marital status, and address.

However, it is also possible that payroll engine 1002a may require all changes made to the employee profile since its generation. In response to determining that the respective payroll engine needs the plurality of changes, method 1500 advances to 1508, where data transformation module 1018 transforms the payroll data 1018 to include the plurality of changes. Referring to table 1, if the salary has changed three times, data transformation module 1008 may generate a change file 1020 that includes the following data: name, salary 1 (timestamp 1), salary 2 (timestamp 2), salary 3 (timestamp 3), marital status, and address. From 1506 and 1508, method 1500 advances to 1510, where data transformation module 1018 transmits, to the respective payroll engine (e.g., payroll engine 1002a), the payroll data 1018 transformed in a change file 1020.

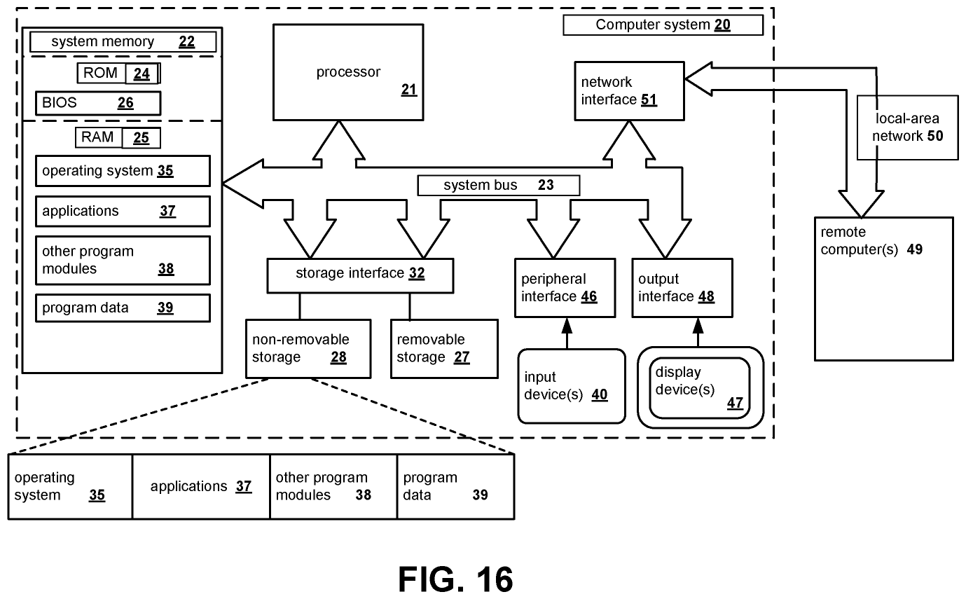

FIG. 16 is a block diagram illustrating a computer system 20 on which aspects of systems and methods for applying data transformations on payroll data may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-15 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A system for processing payroll data, comprising:
at least one memory;
at least one hardware processor coupled with the at least one memory and configured, individually or in combination, to:
identify a plurality of payroll engines for a company, wherein each respective payroll engine of the plurality of payroll engines is configured to process payroll transactions for employees in a unique geographic location of a plurality of geographic locations;
for each respective payroll engine of the plurality of payroll engines:
determine, from a plurality of data types, a respective subset of data types unique to the respective payroll engine and needed to process the payroll transactions based on the unique geographic location associated with the respective payroll engine; and
determine a respective data format required by the respective payroll engine to process the payroll transactions;
receive payroll data of an employee;
in response to determining that the employee is associated with a first geographic location of the plurality of geographic locations, transform the payroll data corresponding to a first subset of data types into a first data format of the first geographic location; and
transmit the payroll data transformed to a first payroll engine of the first geographic location.

2. The system of claim 1, wherein the payroll data comprises, for a respective employee, a plurality of changes applied to an employee profile, and wherein the at least one hardware processor is configured to transform the payroll data by:
indicating each change of the plurality of changes by a timestamp;
determining whether the respective payroll engine needs a latest change or the plurality of changes; and
transforming the payroll data to include solely the latest change in response to determining that the respective payroll engine needs the latest change; or
transforming the payroll data to include the plurality of changes in response to determining that the respective payroll engine needs the plurality of changes.

3. The system of claim 2, wherein a change of the plurality of changes includes one or more of: an addition to the employee profile, a deletion from the employee profile, a modification to the employee profile.

4. The system of claim 2, wherein the at least one hardware processor is further configured to transmit, to the respective payroll engine, the payroll data transformed in a change file.

5. The system of claim 1, wherein processing the payroll transactions comprises executing a function for calculating one or more of: taxes, salary, credits, and fees, wherein the function is specific to a legislative structure of the unique geographic location.

6. The system of claim 1, wherein the payroll data comprises one or more of: an employee name, an employee address, a job role, a salary, a frequency of pay, a contract length, a government-issued identifier, a company-issued identifier, an amount of dependents, years of experience.

7. The system of claim 1, wherein the at least one hardware processor is configured to:
determine, from the plurality of data types, the first subset of data types needed by the first payroll engine of the plurality of payroll engines;
determine the first data format required by the first payroll engine to process a payroll transaction.

8. The system of claim 7, wherein the at least one hardware processor is configured to:
determine, from the plurality of data types, a second subset of data types needed by a second payroll engine of the plurality of payroll engines;
determine a second data format required by the second payroll engine to process a payroll transaction.

9. The system of claim 8, wherein the first subset of data types is different than the second subset of data types, and wherein the first data format is different than the second data format.

10. The system of claim 1, wherein the at least one hardware processor is configured to transmit the payroll data to a second payroll engine of a second geographic location in response to determining that the payroll data is associated with one or more employees associated with the first geographic location.

11. The system of claim 1, wherein the unique geographic location is one of a town, a city, a country, a continent.

12. A method for processing payroll data, comprising:
identifying a plurality of payroll engines for a company, wherein each respective payroll engine of the plurality of payroll engines is configured to process payroll transactions for employees in a unique geographic location of a plurality of geographic locations;
for each respective payroll engine of the plurality of payroll engines:
determining, from a plurality of data types, a respective subset of data types unique to the respective payroll engine and needed to process the payroll transactions based on the unique geographic location associated with the respective payroll engine; and
determining a respective data format required by the respective payroll engine to process the payroll transactions;
receiving payroll data of an employee;
in response to determining that the employee is associated with a first geographic location of the plurality of geographic locations, transforming the payroll data corresponding to a first subset of data types into a first data format of the first geographic location; and
transmitting the payroll data transformed to a first payroll engine of the first geographic location.

13. The method of claim 12, wherein the payroll data comprises, for a respective employee, a plurality of changes applied to an employee profile, further comprising transforming the payroll data by:
indicating each change of the plurality of changes by a timestamp;
determining whether the respective payroll engine needs a latest change or the plurality of changes; and
transforming the payroll data to include solely the latest change in response to determining that the respective payroll engine needs the latest change; or
transforming the payroll data to include the plurality of changes in response to determining that the respective payroll engine needs the plurality of changes.

14. The method of claim 13, wherein a change of the plurality of changes includes one or more of: an addition to the employee profile, a deletion from the employee profile, a modification to the employee profile.

15. The method of claim 13, further comprising transmitting, to the respective payroll engine, the payroll data transformed in a change file.

16. The method of claim 12, wherein processing the payroll transactions comprises executing a function for calculating one or more of: taxes, salary, credits, and fees, wherein the function is specific to a legislative structure of the unique geographic location.

17. The method of claim 12, wherein the payroll data comprises one or more of: an employee name, an employee address, a job role, a salary, a frequency of pay, a contract length, a government-issued identifier, a company-issued identifier, an amount of dependents, years of experience.

18. The method of claim 12, further comprising:
determining, from the plurality of data types, the first subset of data types needed by the first payroll engine of the plurality of payroll engines;
determining the first data format required by the first payroll engine to process a payroll transaction.

19. The method of claim 18, further comprising:
determining, from the plurality of data types, a second subset of data types needed by a second payroll engine of the plurality of payroll engines;
determining a second data format required by the second payroll engine to process a payroll transaction.

11. A non-transitory computer readable medium storing thereon computer executable instructions for processing payroll data, including instructions for:
identifying a plurality of payroll engines for a company, wherein each respective payroll engine of the plurality of payroll engines is configured to process payroll transactions for employees in a unique geographic location of a plurality of geographic locations;
for each respective payroll engine of the plurality of payroll engines:
determining, from a plurality of data types, a respective subset of data types unique to the respective payroll engine and needed to process the payroll transactions based on the unique geographic location associated with the respective payroll engine; and
determining a respective data format required by the respective payroll engine to process the payroll transactions;
receiving payroll data of an employee;
in response to determining that the employee is associated with a first geographic location of the plurality of geographic locations, transforming the payroll data corresponding to a first subset of data types into a first data format of the first geographic location; and
transmitting the payroll data transformed to a first payroll engine of the first geographic location.
